(19) United States
(12) Patent Application Publication
(10) Pub. No.: US 2026/0039656 A1
(43) Pub. Date: Feb. 5, 2026

(54) PROTECTING NEAR FIELD COMMUNICATION (NFC)

(71) Applicant: The Ninth LLC, Addison, TX (US)

(72) Inventors: Suzanne Annette Young, Dallas, TX (US); Keite Young, Dallas, TX (US); Joshua Brian Herrington, Austin, TX (US); Delfino Galindo, Grand Prairie, TX (US)

(21) Appl. No.: 19/288,405

(22) Filed: Aug. 1, 2025

Related U.S. Application Data
(60) Provisional application No. 63/678,252, filed on Aug. 1, 2024.

(51) Int. Cl. H04L 9/40; H04B 5/70

(52) U.S. Cl. CPC H04L 63/0853; H04B 5/70

(57) ABSTRACT

Methods, systems, and apparatus, including computer programs encoded on computer storage media, for protecting near field communication (NFC). One of the methods includes obtaining, using a first Near Field Communication (NFC) device, an embedded encrypted key from a second NFC device; generating, using the embedded encrypted key from the second NFC device, a resource request including the embedded encrypted key from the second NFC device; transmitting the resource request to a verifying component; in response to transmitting the resource request, obtaining response data from the verifying component configured to cause a device coupled to the first NFC device to perform an action.

### CROSS-REFERENCE TO RELATED APPLICATIONS

This application claims the benefit of U.S. Provisional Application No. 63/678,252, filed Aug. 1, 2024, the contents of which are incorporated by reference herein.

### TECHNICAL FIELD

This specification relates to Near Field Communication (NFC) technology.

### BACKGROUND

NFC is a short-range wireless connectivity technology that allows NFC-enabled devices to communicate with each other using inductive coupling of two electromagnetic coils.

### SUMMARY

In general, one innovative aspect of the subject matter described in this specification can be embodied in methods that include the actions of obtaining, using a first Near Field Communication (NFC) device, an embedded encrypted key from a second NFC device; generating, using the embedded encrypted key from the second NFC device, a resource request, wherein the resource request includes the embedded encrypted key from the second NFC device; transmitting the resource request to a verifying component; in response to transmitting the resource request, obtaining response data from the verifying component configured to cause a device coupled to the first NFC device to perform an action.

The foregoing and other embodiments can each optionally include one or more of the following features, alone or in combination. In particular, one embodiment includes all the following features in combination. Feature 1: Transmitting the resource request to the verifying component comprises transmitting the resource request to a network server. Feature 2: Obtaining the embedded encrypted key from the second NFC device comprises obtaining N characters, wherein N represents any number, and wherein the characters uniquely identify an object coupled to the second NFC device. Feature 3: N is equal to thirty-three. Feature 4: Actions include obtaining, from the first NFC device, the resource request that includes the embedded encrypted key from the second NFC device; generating, using the obtained resource request, the response data; determining that the response data satisfies a response threshold; and in response to the response data satisfying the response threshold, performing a set of actions that include the action. Feature 5: The second NFC device comprises: a body adhesively coupled to a metallic layer configured to cover the second NFC device when adhesively coupled to the body. Feature 6: The metallic layer comprises copper or aluminum. Feature 7: The body is configured to enclose a chemical compound. Feature 8: The body is configured to dispense the chemical compound. Feature 9: Actions include maintaining a first database of values, wherein the first database of values includes a first set of values associated with a user of the first NFC device; maintaining a second database of values, wherein the second database of values includes a second set of values associated with the embedded encrypted key from the second NFC device, wherein the method comprises: obtaining, from the first NFC device, the resource request that includes the embedded encrypted key from the second NFC device; generating, using both (i) the obtained resource request and (ii) the second database of values, the response data; determining that the response data satisfies a response threshold; and in response to the response data satisfying the response threshold, performing a set of actions that include adjusting at least one of the first set of values associated with the user of the first NFC device.

In general, another innovative aspect of the subject matter described in this specification can be embodied in methods that include the actions of obtaining, from a device, a first set of one or more resource requests that each include a same encrypted key; determining, using the obtained first set of one or more resource requests, a verification indicator; and performing an action based on the verification indicator.

Other embodiments of these aspects include corresponding computer systems, apparatus, and computer programs recorded on one or more computer storage devices, each configured to perform the actions of the methods.

Another innovative aspect of the subject matter described in this specification can be embodied in a device that includes a Near Field Communication (NFC) device coupled to a body; and a metallic layer adhesively coupled to the body and configured to cover the NFC device when adhesively coupled to the body. The foregoing and other embodiments can each optionally include one or more of the following features, alone or in combination. In particular, one embodiment includes all the following features in combination. Feature 1: The metallic layer comprises copper or aluminum. Feature 2: The body is configured to enclose a chemical compound. Feature 3: The body is configured to dispense the chemical compound.

The technology described in this specification can be implemented so as to realize one or more of the following advantages. For example, NFC technology suffers from a lack of protection in that NFC signals can be scanned using any NFC device and downstream processes can be unable to identify whether a scanning device of an NFC chip is associated with an authorized or non-authorized user of the NFC chip. Techniques described in this specification solve this issue by, e.g., embedding an encrypted key within an NFC chip to be scanned. The key can then be used by a verification process to determine whether or not a scanning user is authorized or not authorized for scanning the given chip. To physically protect an NFC, metallic layers can be fitted over the NFC chip. This protection, or positioning of the protected NFC chip, can improve the function of objects with NFC chips, e.g., by locating an NFC chip in a manufactured object on the opposite side of a dispensing side of an object to enable scanning while or after dispensing without a dispensing material contaminating a scanning device or by placing the metallic covering over both a dispensing mechanism and an NFC chip to allow a single removal by a user to expose both a dispensing mechanism and an NFC chip for scanning.

NFC technology can be improved by analyzing data obtained from NFC communication networks prior to performing one or more operations. Malicious actors can transmit or receive NFC data—e.g., in an attempt to compromise a device or obtain remuneration through use of the received NFC data. In some cases, a verification process can be performed, either on a scanning device or by one or more computers connected to a scanning device, prior to performing one or more operations. Verification can determine one or more identifying elements of a scanning device or user operating the scanning device. Verification can include detecting whether or not a device or user operating the device is a malicious actor—e.g., that is forcing a scanning device to perform processes that compromise the scanning device a device or is attempting to obtain remuneration through use of received NFC data. A verifying component can generate response data that indicates whether or not the NFC interaction is compromised—e.g., by involvement of a malicious actor. A system can perform mitigating actions or prevent performance of one or more actions in response to an indication that the NFC interaction is compromised. In response to an indication that the NFC interaction is not compromised, the system can perform one or more actions, e.g., where actions can include at least one of actions performed on the scanning device or actions performed on one or more computers communicably connected to the scanning device.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example system.

FIG. 2 is a flowchart of an example process for protecting NFC.

FIG. 3 is a flowchart of another example process for protecting NFC.

FIG. 4 shows example devices.

Like reference numbers and designations in the various drawings indicate like elements.

### DETAILED DESCRIPTION

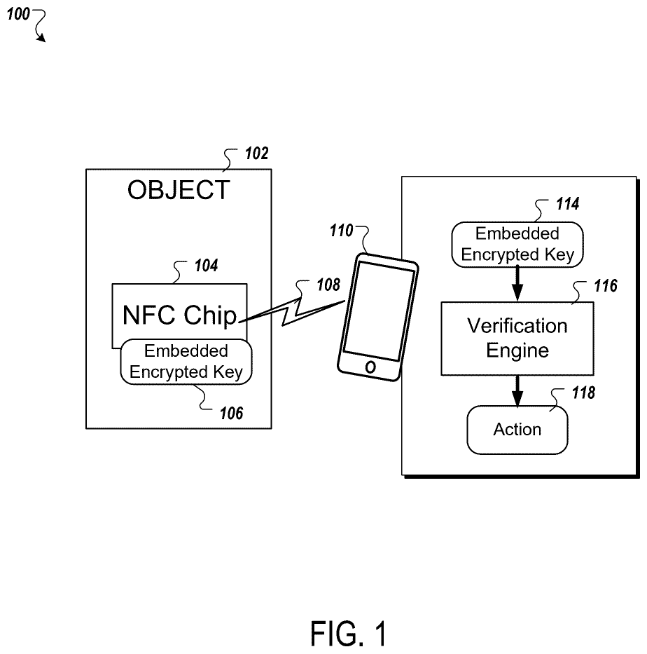

FIG. 1 shows an example system 100. The system 100 includes an NFC chip 104 and an NFC reading device 110. In general, the NFC reading device 110 reads data from the NFC chip 104 and performs, using a verification engine 116, verification processes based on the data from the NFC chip 104. In some cases, the NFC reading device 110 can be a mobile device, such as a smartphone. The NFC chip 104 can be coupled to an object 102.

In some cases, the NFC reading device 110 obtains an embedded encrypted key 106 from the NFC chip 104. For example, the NFC reading device 110 and the NFC chip 104 can be configured with NFC communication elements to enable an NFC signal 108 to be read by the NFC reading device 110 from the NFC chip 104. The NFC signal 108 can include data indicating the embedded encrypted key 106. The embedded encrypted key 106 can be generated at a time of manufacturing the NFC chip 104. In some cases, the encrypted key 106 is embedded in the NFC chip 104. In some cases, the embedded encrypted key 106 is unique to the object 102 or a type of object that classifies the object 102.

In some cases, the NFC reading device 110 generates a resource request. For example, the NFC reading device 110 can generate a resource request using the embedded encrypted key 106. The resource request can include a receipt signal of the NFC signal 108. In some cases, the NFC reading device 110 generates a uniform resource locator (URL) as a resource request. For example, the NFC reading device 110 can obtain information from the NFC chip 104 and use the information to generate a URL, e.g., by including information from the NFC chip 104 within the generated URL. In some cases, the information includes a sequence of characters that uniquely identify the NFC chip 104 or the object 102. In some cases, the information includes a sequence of characters specifying a domain address for a webpage resource. In some cases, the information includes a plurality of parameters, where one parameter of the plurality includes a sequence of characters that uniquely identify at least one of the object 102 or the NFC chip 104.

In some cases, the NFC reading device 110 transmits a generated resource request to a verifying component. For example, the NFC reading device 110 can transmit data indicating the NFC signal 108 to the verification engine 116. The data can include an embedded encrypted key 114 which can match the embedded encrypted key 106 or include additional data or be different from the key 106 but generated using the key 106. In general, the verification engine 116 can use a verification result to perform one or more actions, including the action 118. The action 118 can depend on whether or not a verification is successful or not. The action 118 can include adjusting, such as incrementing or decrementing, one or more values stored and associated with an account used by the NFC reading device 110.

The verification engine 116 can include one or more processes performed on the NFC reading device 110 or by one or more computers communicably connected to the NFC reading device 110, such as one or more server computers. In some cases, the NFC reading device 110 transmits data indicating a generated URL to the verification engine 116. In some cases, the NFC reading device 110 transmits other data indicating the NFC signal 108 to the verification engine 116.

In some cases, the verification engine 116 uses an embedded key, such as data corresponding to the embedded encrypted key 106, to uniquely identify a scan. For example, based on receiving the embedded encrypted key 114, the verification engine 116 can determine that the NFC chip 104 of the object 102 has been scanned by the NFC reading device 110. The verification engine 116 can use data, including the embedded encrypted key 114, to verify or not verify a scan. In some cases, the verification engine 116 queries a database of stored key values. The verification engine 116 can determine if any value of the database matches a value corresponding to the embedded encrypted key 114. The verification engine 116 can determine if the matched value includes a property indicating an authentic scan, e.g., a parameter indicating that a value matching a value included in the embedded encrypted key 114 is uniquely associated with the NFC reading device 110 or an account of the NFC reading device 110. Or an account of the NFC reading device 110 is a registered guest user of the NFC chip 104. Based on one or more values corresponding to the embedded encrypted key 114, the verification engine 116 can determine if a scan is authorized or not.

In some cases, the verification engine 116 performs a verification process using data from multiple scans. For example, the verification engine 116 can collect multiple verification requests where each request indicates an NFC reading device reading an NFC chip corresponding to an object. The verification engine 116 can obtain data indicating NFC scans corresponding to a threshold number of objects within a same category of objects within a threshold time duration, e.g., the verification engine 116 can obtain data indicating ten NFC scans for objects of a chemical enclosure type within five minutes. The verification engine 116 can identify a set of NFC scans if the scans occur within a threshold time duration, such as five minutes. The set of scans can include scans of different NFC chips, e.g., the NFC chip 104 and another chip. In some cases, the verification engine 116 can determine if NFC chips scanned are of a same object type, e.g., a same category of product. The verification engine 116 can compare a set of NFC scans to a threshold number of scans to determine whether or not one or more scans of the set can be verified. A threshold can be any number, such as three.

In some cases, the verification engine 116 can check if two or more accounts use similar information. For example, a scan of an NFC chip can be scanned using a scanning application that requires an account login prior to scanning. After logging into the application, a device running the application equipped with an NFC chip, can scan NFC chips, such as the NFC chip 104 of the object 102. The verification engine 116 can check if multiple accounts use the same information, such as the same address, phone number, email, or IP address. Information used by the verification engine 116 can be obtained based on the NFC signal 108 or other sensors of the NFC reading device 110, such as a Wi-Fi chip. Information can be obtained from user input, e.g., using an interface provided by an application that can also be configured for scanning NFC chips. In some cases, if multiple accounts are detected to use the same information, the verification engine 116 can block scans or indicate that such scans are not verified, and take appropriate action based on that detection.

In some cases, the verification engine 116 detects if multiple chips have been scanned without registering any identifier to an account. For example, if a device scans the same NFC chip a threshold number of times, such as three, the NFC chip can be registered to or associated with a given scanning account. The verification engine 116 can obtain scanning data and store data indicating that a given NFC chip is registered to a given account. For example, the NFC reading device 110 can operate an application logged into a first account corresponding to a user of the NFC reading device 110. If the NFC reading device 110 scans the NFC chip 104 a threshold number of times, the verification engine 116 can detect such scans and store a mapping between the NFC reading device 110, or an account logged into on the NFC reading device 110, and the NFC chip 104, or the object 102 corresponding to the NFC chip 104. In some cases, mappings can use unique identifiers to specify any of a device, account, object, or NFC chip. If the verification engine 116 detects a device scanning a threshold number of items without registering any of the items (e.g., by scanning them at least a threshold number of times), the verification engine 116 can not verify such scans and take appropriate action, e.g., blocking an account or providing a notification to one or more devices.

In general, the verification engine 116 can obtain any data for processes performed by the verification engine 116. For example, the verification engine 116 can obtain data from the NFC reading device 110. The data from the NFC reading device 110 can be generated, at least in part, based on the NFC signal 108.

In some cases, the verification engine 116 detects if a chip is scanned from multiple geo-locations or IP addresses within a threshold amount of time. For example, the verification engine 116 can detect if a chip is scanned by a device at a location X and at a later time at location Y where X and Y are more than a threshold distance apart, e.g., one hundred miles. The distance can be dynamic, e.g., varying with an amount of time. In some cases, the verification engine 116 can determine a distance between scans and a time between scans and determine a rate of speed a user would have to have been traveling for such scans to be genuine. If the speed is greater than a threshold speed, the verification engine 116 can decline to verify one or more scans for the corresponding account or device. Location can be determined by a device, such as the NFC reading device 110 obtaining and providing to the verification engine 116, global positioning data or IP location data. In general, any type of data indicating location can be obtained by the NFC reading device 110 and provided to the verification engine 116, such as location data inferred from nearby device communicably connected to the NFC reading device 110.

In some cases, identifiers can be locked to an account after a threshold number of scans. Identifiers can refer to unique data of the NFC chip 104, such as the embedded encrypted key 106. In some cases, identifiers are locked after a threshold number of scans over the course of a threshold number of consecutive days. For example, the NFC reading device 110 can be locked to the NFC chip 104 after the NFC reading device 110 scans the NFC chip 104 three times over three consecutive days, e.g., at least one scan per day for three consecutive days. In some cases, the verification engine 116, or another element of a device operating the verification engine 116, can lock accounts to identifiers. For example, a server operating the verification engine 116 can obtain data of one or more scans from the NFC reading device 110 and lock one or more scanned chips, corresponding to objects, to the NFC reading device 110 or an account of the NFC reading device 110 in response to determining one or more locking conditions are met, e.g., threshold number of consecutive days with a threshold number of scans per consecutive day.

In some cases, verification engine 116 determines if a maximum number of scans of the NFC chip 104 has been reached. For example, the verification engine 116 can store a number of available scans, or maximum number of scans, for one or more NFC chips, such as the NFC chip 104. The verification engine 116 can obtain data indicating a scan as discussed. The verification engine 116 can compare an identifier associated with the scan to a value indicating a recorded number of scans for the identifier over time. If the number of scans has reached a maximum number of scans, the verification engine 116 can perform a blocking action. If not, the verification engine 116 can verify the scan, e.g., by performing an appropriate action. The number of scans can then be updated based on the current scan, and can then be stored.

In some cases, the verification engine 116 only stores values indicating scans for chips that have been registered, or locked to an account. In this way, the verification engine 116 can reduce a memory footprint for performing the techniques described. After a chip is registered, e.g., in response to a device scanning the chip a threshold number of times, the verification engine 116 can store a maximum value of scans for the chip or a value indicating the currently used scans. In some cases, upon registering, the verification engine 116 can reduce a remaining number of scans by the number of scans used to determine registration, e.g., the verification engine 116 can reduce a maximum number of scans by three where three scans are required before a chip can be locked to a user.

To illustrate this process, if the NFC chip 104 of the object 102 is scanned by three separate devices, these scans will not reduce a maximum number of scans available for the NFC chip 104. However, upon registering the NFC chip to the NFC reading device 110 (e.g., after a threshold number of scans or a threshold amount of time), the verification engine 116 or other element can store an available scan value of X minus Y, where X represents the total number of allowed scans and Y represents the amount of scans performed to register the NFC chip to a given account or device.

In some cases, the verification engine 116 determines whether the NFC chip 104 is already locked to an account. For example, the verification engine 116 can obtain data indicating the NFC reading device 110 scanned the NFC chip 104, e.g., data including the embedded encrypted key 114. The verification engine 116 can determine whether or not the NFC chip has been previously registered with another account or device different from the account operating on the NFC reading device 110 or the NFC reading device 110. If the previously registered account or device is different than a current scanning account or device, the verification engine 116 can perform a blocking action. A blocking action can include providing a webpage to a scanning device configured to display an interface for obtaining a different object similar to the object 102.

In some cases, the verification engine 116 can verify scans as guest scans, e.g., for a threshold number of guests. For example, the verification engine 116 can verify scans by X different accounts as guest scans, where X can be any number. For X+1th guest, the verification engine 116 can block the scan, e.g., by performing a blocking action. In some cases, guest scans are limited per guest. For example, each guest can be limited to three scans before the verification engine 116 performs blocking actions in response to scans. The verification engine 116 can store mappings of guest users to specific identifiers represent chips or objects and can store values representing a number of scans for one or more guests. The verification engine 116 can compare a current number of scans to a maximum number of scans for guests, e.g., to determine an appropriate action to perform.

In some cases, the action 118 includes a delay. For example, the verification engine 116 can perform one or more actions using a delay of X number of days, where X can represent any number. In some cases, the verification engine 116 can perform operations to increment a total reward point value for an account in response to a device logged into the given account scanning an NFC chip, such as the NFC chip 104. The verification engine 116 can delay the increment of values for a period of time or until one or more conditions are met. Conditions can include a certain number of scans over a period of time by the same account or device of the same NFC chip. In some cases, if one or more conditions are not met within a threshold period of time, such as two months, the verification engine 116 can remove incremented values or not increment them.

In some cases, the verification engine 116 performs one or more operations in response to verifying one or more scans. For example, the verification engine 116 can perform the action 118. The action 118 can include transmitting response data to the NFC reading device 110. The response data can be configured to cause the NFC reading device 110 to perform an action, such as display an interface on a screen of the NFC reading device 110. The interface can be specific to the verification process, e.g., indicating a first interface for a successful scan and a second interface for an unsuccessful scan. In some cases, the interface notifies a user of the NFC reading device 110 that a scan was either successful or not successful. In some cases, the interface informs a user of the NFC reading device 110 about the object 102 or items related to the object 102.

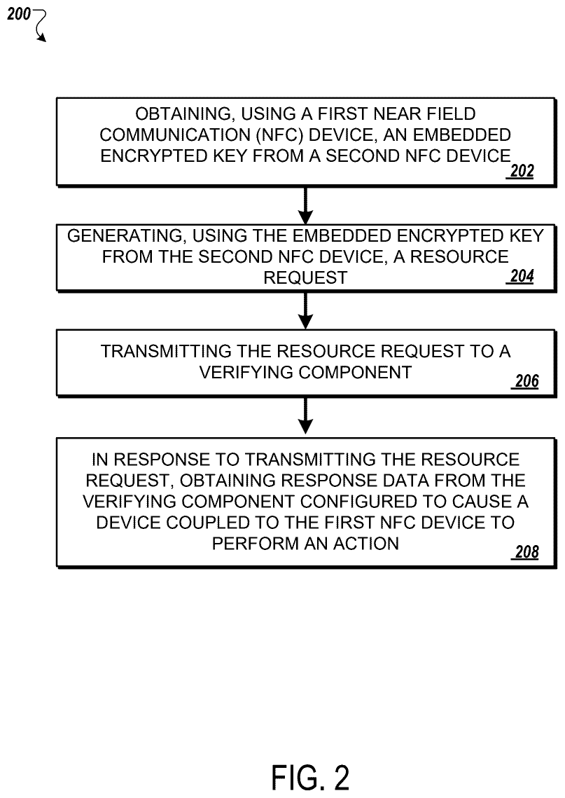

FIG. 2 is a flowchart of an example process 200 for protecting NFC. For convenience, the process 200 will be described as being performed by a system of one or more computers, located in one or more locations, and programmed appropriately in accordance with this specification. For example, a system, e.g., the system 100 of FIG. 1, appropriately programmed, can perform the process 200.

The process 200 includes obtaining, using a first Near Field Communication (NFC) device, an embedded encrypted key from a second NFC device (202). For example, the NFC reading device 110 can obtain the embedded encrypted key 106 from the NFC chip 104.

The process 200 includes generating, using the embedded encrypted key from the second NFC device, a resource request (204). For example, the NFC reading device 110 can generate data including the embedded encrypted key 114.

The process 200 includes transmitting the resource request to a verifying component (206). For example, the NFC reading device 110 can transmit the data including the embedded encrypted key 114 to the verification engine 116.

The process 200 includes, in response to transmitting the resource request, obtaining response data from the verifying component configured to cause a device coupled to the first NFC device to perform an action (206). For example, the NFC reading device 110 can obtain response data from the verification engine 116 and be configured to perform the action 118 or operations corresponding to the action 118 in response.

In some cases, transmitting the resource request to the verifying component includes transmitting the resource request to a network server. For example, the verification engine 116 can include a network server. The NFC reading device 110 can be communicably connected to one or more servers.

In some cases, obtaining the embedded encrypted key from the second NFC device includes obtaining N characters. For example, N can represent any number. Characters obtained can uniquely identify an object coupled to the second NFC device, e.g., the object 102 coupled to the NFC chip 104. In some cases, N is equal to thirty-three.

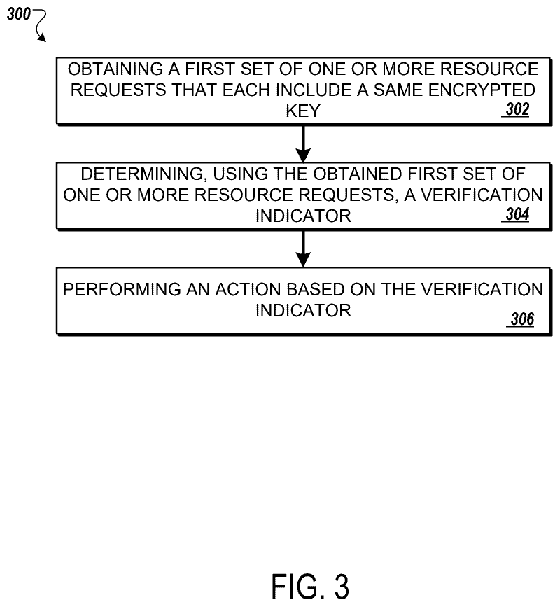

FIG. 3 is a flowchart of another example process 300 for protecting NFC. For convenience, the process 300 will be described as being performed by a system of one or more computers, located in one or more locations, and programmed appropriately in accordance with this specification. For example, a system, e.g., the system 100 of FIG. 1, appropriately programmed, can perform the process 300.

The process 300 includes obtaining a first set of one or more resource requests that each include a same encrypted key (302). For example, the verification engine 116 can obtain data including the embedded encrypted key 114 for one or more scans by one or more devices. The verification engine 116 can be performed on one or more computers, including the NFC reading device 110 or a server connected to the NFC reading device 110. The resource requests can include a URL that includes the embedded encrypted key 114.

The process 300 includes determining, using the obtained first set of one or more resource requests, a verification indicator (304). For example, the verification engine 116 can determine a verification indicator indicating whether or not a scan is successful. Successful scans can include scans by a device logged into an account that is locked to a given chip being scanned, scans by a device registered as a guest user of a chip, or scans that are within a threshold maximum number of scans for a given chip.

The process 300 includes performing an action based on the verification indicator (306). For example, the verification engine 116 can provide data to the NFC reading device 110 to cause the NFC reading device 110 to perform actions. The NFC reading device 110 can be configured to display one or more interfaces based on one or more actions. In some cases, actions include incrementing a value stored that is associated with one or more accounts of devices that have scanned one or more chips. Actions can occur after a predetermine amount of time after the verification engine 116 determines a given action to be performed, e.g., after a delay of hours, days, or another period of time.

In some cases, the process 300, or the process 200, includes generating response data using one or more obtained resource requests. The processes can include determining that the response data satisfies a response threshold. The response threshold can indicate whether or not an NFC interaction is compromised—e.g., by a malicious actor. The processes can include performing a set of actions that include an action performed by a scanning device. For example, the set of actions can include actions to adjust one or more values stored in a database corresponding to an identifier of a user of a scanning device, such as the NFC reading device 110.

In some cases, the process 300, or the process 200, includes maintaining one or more databases of values. The databases of values can represent values associated with at least one of the NFC reading device 110, the object 102, or the NFC chip 104. The databases can represent values associated with one or more identifiers of users. The database of values associated with at least one of the NFC reading device 110, the object 102, or the NFC chip 104 can be used for verifying an NFC interaction. One or more of the databases can be used, at least in part, to perform the action 118. The database of values associated with one or more identifiers of users can be used to adjust one or more values, e.g., in response to determining that a given NFC interaction is not compromised. In some cases, a database of values associated with at least one of the NFC reading device 110, the object 102, or the NFC chip 104 can be used for verification—e.g., to verify whether or not a given embedded encrypted key is associated with a given entity or included in the database. In some cases, inclusion for an entry corresponding to a particular entity or inclusion in a database can be used by a verifying component to generate response data that indicates an NFC interaction is not compromised.

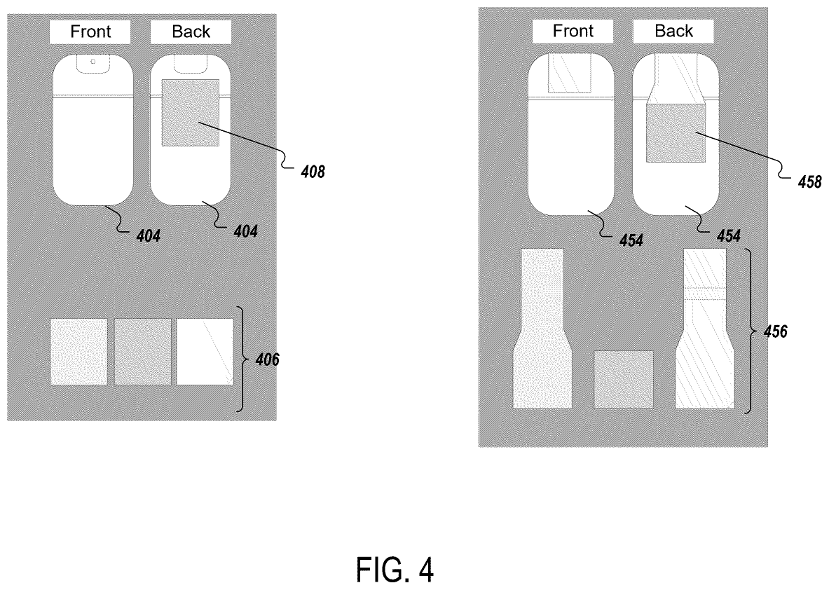

FIG. 4 shows example devices 404 and 454. The example device 404 and 454 show example techniques for physically protecting NFC signals from an NFC chip included in the devices 404 and 454. NFC signals can be protected using a metallic layer coupled to the body of a device, such as the device 404 or device 454. The metallic layer can be adhesively coupled. The metallic layer can be configured to cover an NFC chip of a device, such as the NFC chip 104 of the object 102. The metallic layer can be made of copper, aluminum, or other materials capable of blocking NFC signals.

In some cases, a device, such as device 404, can enclose a chemical compound. For example, a liquid, gel, or gas can be enclosed in the device 404. An NFC chip coupled to the device 404 can be used in connection with use of the chemical compound, e.g., being scanned for each use of the chemical compound. The device, such as the device 404, can be configured to dispense a chemical compound, e.g., using a sprayer, outlet, spring, or other suitable mechanism.

A metallic layer 408 can be attached to a back of the device 404. The metallic layer 408 can, in some cases, be attached to the front or other side of the device 404. In some cases, the metallic layer 408 is attached to a side opposite a side used for dispensing a material enclosed by the device 404, such as side including a dispensing mechanism. By locating the NFC chip on the opposite side of the dispensing side, the device 404 can allow for easier scanning of the NFC chip of the device 404, e.g., without exposure to the dispensing material or while dispensing of the material. Layers 406 illustrate varying potential materials that can be used to physically block an NFC signal of an NFC chip coupled to the device 404.

A metallic layer 458 can be attached to the back of the device 454. In some cases, the metallic layer 458 can be coupled to a layer that wraps from one side of the device 454 to another, e.g., from a front side to a back side. The layers 456 illustrate varying materials that can be used to block an NFC signal of an NFC chip coupled to the device 454. In some cases, the layer wrapping over the NFC chip and around to another side is one layer of metallic material. In some cases, the layer includes metallic and non-metallic material. In some cases, the layer can be attached to increase an case of removing the layer by a user. For example, a layer can cover both a dispensing mechanism of the device 454 and the NFC chip. Before use, a user can remove the layer, e.g., that can be adhesively applied to the device 454. Because the layers are connected, a user need only remove a layer once to expose the device 454 and to ready the device 454 for both use in scanning and in dispensing a material at least partially enclosed by the device 454.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining, using a first Near Field Communication (NFC) device, an embedded encrypted key from a second NFC device;
generating, using the embedded encrypted key from the second NFC device, a resource request, wherein the resource request includes the embedded encrypted key from the second NFC device;
transmitting the resource request to a verifying component; and
in response to transmitting the resource request, obtaining response data from the verifying component configured to cause a device coupled to the first NFC device to perform an action.

2. The method of claim 1, wherein transmitting the resource request to the verifying component comprises:
transmitting the resource request to a network server.

3. The method of claim 1, wherein obtaining the embedded encrypted key from the second NFC device comprises:
obtaining N characters, wherein N represents any number, and wherein the characters uniquely identify an object coupled to the second NFC device.

4. The method of claim 3, wherein N is equal to thirty-three.

5. The method of claim 1, comprising:
obtaining, from the first NFC device, the resource request that includes the embedded encrypted key from the second NFC device;
generating, using the obtained resource request, the response data;
determining that the response data satisfies a response threshold; and
in response to the response data satisfying the response threshold, performing a set of actions that include the action.

6. The method of claim 1, wherein the second NFC device comprises:
a body adhesively coupled to a metallic layer configured to cover the second NFC device when adhesively coupled to the body.

7. The second NFC device of claim 6, wherein the metallic layer comprises copper or aluminum.

8. The second NFC device of claim 6, wherein the body is configured to enclose a chemical compound.

9. The second NFC device of claim 8, wherein the body is configured to dispense the chemical compound.

10. The method of claim 1, comprising:
maintaining a first database of values, wherein the first database of values includes a first set of values associated with a user of the first NFC device;
maintaining a second database of values, wherein the second database of values includes a second set of values associated with the embedded encrypted key from the second NFC device, wherein the method comprises:
obtaining, from the first NFC device, the resource request that includes the embedded encrypted key from the second NFC device;
generating, using both (i) the obtained resource request and (ii) the second database of values, the response data;
determining that the response data satisfies a response threshold; and
in response to the response data satisfying the response threshold, performing a set of actions that include adjusting at least one of the first set of values associated with the user of the first NFC device.

11. One or more computer-readable storage media encoded with instructions that, when executed by one or more computers, cause the one or more computers to perform operations comprising:
obtaining, using a first Near Field Communication (NFC) device, an embedded encrypted key from a second NFC device;
generating, using the embedded encrypted key from the second NFC device, a resource request, wherein the resource request includes the embedded encrypted key from the second NFC device;
transmitting the resource request to a verifying component; and
in response to transmitting the resource request, obtaining response data from the verifying component configured to cause a device coupled to the first NFC device to perform an action.

12. The media of claim 11, wherein transmitting the resource request to the verifying component comprises:
transmitting the resource request to a network server.

13. The media of claim 11, wherein obtaining the embedded encrypted key from the second NFC device comprises:
obtaining N characters, wherein N represents any number, and wherein the characters uniquely identify an object coupled to the second NFC device.

14. The media of claim 13, wherein N is equal to thirty-three.

15. The media of claim 11, wherein the operations comprise:
obtaining, from the first NFC device, the resource request that includes the embedded encrypted key from the second NFC device;
generating, using the obtained resource request, the response data;
determining that the response data satisfies a response threshold; and
in response to the response data satisfying the response threshold, performing a set of actions that include the action.

16. The media of claim 11, wherein the second NFC device comprises:
a body adhesively coupled to a metallic layer configured to cover the second NFC device when adhesively coupled to the body.

17. A system comprising:
one or more computers and one or more storage devices on which are stored instructions that are operable, when executed by the one or more computers, to cause the one or more computers to perform operations comprising:
obtaining, using a first Near Field Communication (NFC) device, an embedded encrypted key from a second NFC device;
generating, using the embedded encrypted key from the second NFC device, a resource request, wherein the resource request includes the embedded encrypted key from the second NFC device;
transmitting the resource request to a verifying component; and
in response to transmitting the resource request, obtaining response data from the verifying component configured to cause a device coupled to the first NFC device to perform an action.

18. The system of claim 17, wherein transmitting the resource request to the verifying component comprises:
transmitting the resource request to a network server.

19. The system of claim 17, wherein obtaining the embedded encrypted key from the second NFC device comprises:
obtaining N characters, wherein N represents any number, and wherein the characters uniquely identify an object coupled to the second NFC device.

20. The system of claim 17, wherein the operations comprise:
obtaining, from the first NFC device, the resource request that includes the embedded encrypted key from the second NFC device;
generating, using the obtained resource request, the response data;
determining that the response data satisfies a response threshold; and
in response to the response data satisfying the response threshold, performing a set of actions that include the action.
